(19) United States
(12) Patent Application Publication
(10) Pub. No.: US 2006/0008027 A1
(43) Pub. Date: Jan. 12, 2006

(54) Method for the adaptive pre-distortion of digital raw data values and device for carrying out said method

(76) Inventors: Yingjie Gao, Moers (DE); Ralf Kern, Bocholt (DE); Rolf Theisen, Bocholt (DE)

Correspondence Address: BELL, BOYD & LLOYD, LLC, P. O. BOX 1135, CHICAGO, IL, 60690-1135, US

(21) Appl. No.: 10/530,666

(22) PCT Filed: Oct. 2, 2003
(86) PCT No.: PCT/DE03/03292

§ 371 Date: Apr. 6, 2005

(51) Int. Cl. H04K 1/02

(52) U.S. Cl. 375/297

(57) ABSTRACT

A method is provided for the adaptive pre-distortion of digital raw data values for a communication appliance output stage having a power amplifier, the method including the following steps: a) the raw data values (Vₘ) are pre-distorted by multiplying the raw data values by pre-distortion values from a lookup table (2) containing an association between amplitudes of the raw data values and pre-distortion values; b) output signal values (Vᵣ) of the power amplifier (6) are redirected to an adaptation unit (9); d) temporally corresponding raw data values and output signal values are compared in the adaptation unit in order to assess the distortions of the power amplifier (6); and e) the lookup table (2) is adapted on the basis of results of step d). The present invention seeks to dispense with computing power required to adapt pre-distortion values. To this end, the adaptation unit (9) functions discontinuously and the pre-distortion values of the lookup table (2) are interpolated/extrapolated at least for non-occurring raw data values (Vₘ). A device is also provided for carrying out the inventive method.

### BACKGROUND OF THE INVENTION

The present invention relates to a method for adaptive predistortion of digital raw data values for a transmission output stage, which has a power amplifier, for a communication appliance, as well as to an apparatus for carrying out the method

The specialist article “Amplifier Linearisation Using Adaptive Digital Predistortion” by S. P. Stapleton, which appeared on pages 72 to 77 of “Applied Micro Wave & Wireless,” February 2001, discloses a method for adaptive predistortion having the following steps:
a) predistortion of the raw data values by multiplication of the raw data values by predistortion values from a reference table in order to compensate for amplitude-dependent and phase-dependent distortion in the power amplifier, wherein the reference table contains an association between amplitudes of the raw data values and predistortion values,
b) feeding back of output signal values from the power amplifier to an adaptation unit,
c) passing the raw data values to the adaptation unit,
d) comparison in the adaptation unit of raw data values and output signal values which correspond to one another in time, in order to assess the distortion in the power amplifier,
e) adaptation of the reference table on the basis of results from step d), during operation of the power amplifier (6).

This method is carried out continuously and has the following purpose:

The requirement for higher transmission rates and higher spectral efficiency in modern mobile telecommunications technology has led to “higher level” modulation forms such as QAM or QPSK becoming more important, while modulation methods with a constant envelope curve such as FSK or GMSK have become less interesting. In the first-mentioned modulation methods, both the amplitude and the phase of a transmission signal contain information. Thus is necessary for both the amplitude and the phase to remain as undistorted as possible during amplification by the power amplifier.

However, it must be remembered that all real power amplifiers (in contrast to the ideal situation of a straight line as the characteristic) have a non-linear transmission characteristic.

Power amplifiers such as these which operate non-linearly can be characterized using so-called AM-AM conversion (that is to say, the amplitude of the output signal values from the power amplifier is dependent on the amplitude of the raw data values) and AM-PM conversion (that is to say, the phase shift, which is dependent on the amplitude of the raw data values, in the power amplifier).

The non-linearity of the transmission characteristic of real power amplifiers leads to distortion. In this case, harmonics of a fundamental frequency are produced, at the output of the power amplifier, in addition to the fundamental frequency. In a situation in which there are at least two fundamental frequencies at the input of the power amplifier, then the harmonics of these fundamental frequencies are produced, in which case harmonic mixing also occurs. Harmonics that are produced can be suppressed by suitable filtering measures. However, this is not true of intermodulation products which are close to the fundamental frequency, owing to the frequency mixing of the harmonics as described above. To this extent, the useful signal or the output signal from the power amplifier is interfered with by the intermodulation products. This interference can be suppressed by a back-off which is chosen to be suitably high, thus reducing the non-linearity of the transmission characteristic of the power amplifier and resulting in linearized operation. However, this reduces the cost-effectiveness of the power amplifier owing to the increased power consumption.

The intermodulation products which cannot be suppressed by filtering measures likewise may be overcome through additional design measures; that is to say, the addition of electronic components. This includes a design for adaptive, digital predistortion by which interference close to the channel is distributed over a wider frequency spectrum, so that its amplitude is reduced.

In this context, it is known for a reference table for predistortion to be calculated on the basis of measurements on the power amplifier. However, matching to changed environmental conditions, such as a rise in operating temperature or a change in the supply voltage for the power amplifier, is not possible with such static predistortion.

In contrast, the specialist article cited above describes a predistortion method in which the reference table for the predistortion is continuously adapted in real time. This is done on the basis of a comparison of the amplitudes and phases of raw data values with those of output signal values from the power amplifier. The predistortion values are set on this basis such that the distortion is compensated for, in each case, for one operating point of the power amplifier.

However, continuous adaptation of the reference table in real time has the disadvantage that it requires a very large amount of computation complexity.

US 2002/0044014 A1 discloses a method and an apparatus for linearization of a power amplifier in which predistortion values are updated off-line. This is based on the assumption that any errors in an amplifier chain vary comparatively slowly in comparison to a change in the input signal, so that there is no need for real-time adaptation. In order to calculate new predistortion values, the document states that these also can, in some cases, be interpolated.

Against this background, the present invention seeks to provide a method for adaptive predistortion for a power amplifier, which requires less computation power, as well as an apparatus for carrying out a method so described.

### SUMMARY OF THE INVENTION

With regard to the method, this is achieved by a method for adaptive predistortion of digital raw data values for a transmission output stage, which has a power amplifier, of a communication appliance, such as a mobile communication terminal or a base station in a mobile radio network, having the following steps:
a) predistortion of the raw data values by multiplication of the raw data values by predistortion values from a reference table in order to compensate for amplitude-dependent distortion in the power amplifier, wherein the reference table contains an association between amplitudes of the raw data values and predistortionvalues;
b) feeding back of output signal values from the power amplifier to an adaptation unit;
c) passing the raw data values to the adaptation unit;
d) comparison in the adaptation unit of raw data values and output signal values which correspond to one another in time, in order to assess the distortion in the power amplifier; and
e) adaptation of the reference table on the basis of results from step d), wherein the adaptation unit operates discontinuously during operation of the power amplifier and the predistortion values in the reference table are interpolated/extrapolated at least for raw data values which do not occur.

An advantage of this method is that considerable computation power required for predistortion can be saved in comparison to the prior art. This is achieved by not continuously adapting the reference table to which access is made for suitable predistortion of the raw data values. Instead, the adaptation unit operates discontinuously, thus deliberately dispensing with the need to use a complete collection of mutually associated pairs of raw data values and output signal values from the power amplifier for adaptation. At least those predistortion values for which no matching pairs of raw data values and output signal values occur owing to the discontinuous operation of the adaptation unit are automatically supplemented in the reference table. For this purpose, the associated predistortion values are interpolated or extrapolated, depending on the position of the missing raw data value/output signal value pair within the amplitude spectrum that is used.

The adaptation process is preferably carried out within time windows on the basis of results from step d). Within time windows such as these, both raw data values and output signal values are collected and compared with one another in step d) in order to allow a statement to be made about the distortion of the amplitude and/or phase of the raw data values in the power amplifier.

In this case, an interval between successive time windows can be defined as a function of external parameters which influence the distortion in the power amplifier, and of any desired adjacent channel interference suppression. By way of example, the operating temperature of the power amplifier and its power supply influence the distortion behavior of the power amplifier; that is to say, its non-linear transmission characteristics. The extent to which linearization of the power amplifier is desirable depends on the suppression, particularly of the intermodulation products at the output of the power amplifier which is specified; for example, by a mobile radio standard.

A polynomial for the amplitudes of the output signal values can be calculated for each time window as a function of the amplitudes of the raw data values, with the predistortion values in the reference table being determined on the basis of the function values of the polynomial. In this case, in detail, the adaptation unit is used to calculate coefficients of a polynomial which is, in principle, suitable for describing the profile of the output signal values as a function of the raw data values. For the sake of simplicity, the output signal values can be normalized with respect to the overall gain of the power amplifier, which is calculated from the maximum value of the output signal values and the maximum value of the raw data values.

The use of the polynomial has an advantage that it smoothes the profile of the predistortion values. The polynomial also may be used for extrapolation/ interpolation of missing raw data value/output signal value pairs in the relevant time window.

It should be stressed that both real and complex predistortion values can be used for processing in the method. This depends on whether phase distortion in the power amplifier is also significant. Step d) can be used directly to determine whether such significance exists. If, for example, the comparison leads to the phases of the raw data values and the output signal values having only minor differences, there is no need for phase correction by appropriate predistortion, and the process is carried out exclusively with real predistortion values. These real predistortion values are used to compensate for the amplitude distortion in the power amplifier.

With regard to the apparatus, of the present invention an apparatus is provided for linearization of a transmission amplifier in a communication appliance, such as a mobile communication terminal or a base station in a mobile radio network, having:

a multiplier for multiplication of digital raw data values by predistortion values in order to compensate for amplitude-dependent distortion in the power amplifier, wherein the reference table contains an association between amplitudes of the raw data values and predistortion values; and an adaptation unit, to which output signal values from the power amplifier and the raw data values are passed synchronized in time and which is designed for adaptation of the reference table, during operation of the power amplifier, wherein the adaptation unit has a timer which defines a time window which is used for discontinuous adaptation of the reference table and interpolates/extrapolates the reference table, at least for raw data values which do not occur.

The timer that is provided is intended to define the time window within which the raw data values and output signal values are collected for adaptation of the predistortion values, which then may be processed further in the adaptation unit.

Additional features and advantages of the present invention are described in, and will be apparent from, the following Detailed Description of the Invention and Figures.

### BRIEF DESCRIPTION OF THE FIGURES

FIG. 1 shows a schematic block diagram of a transmission output stage of a mobile communication terminal.

### DETAILED DESCRIPTION OF THE INVENTION

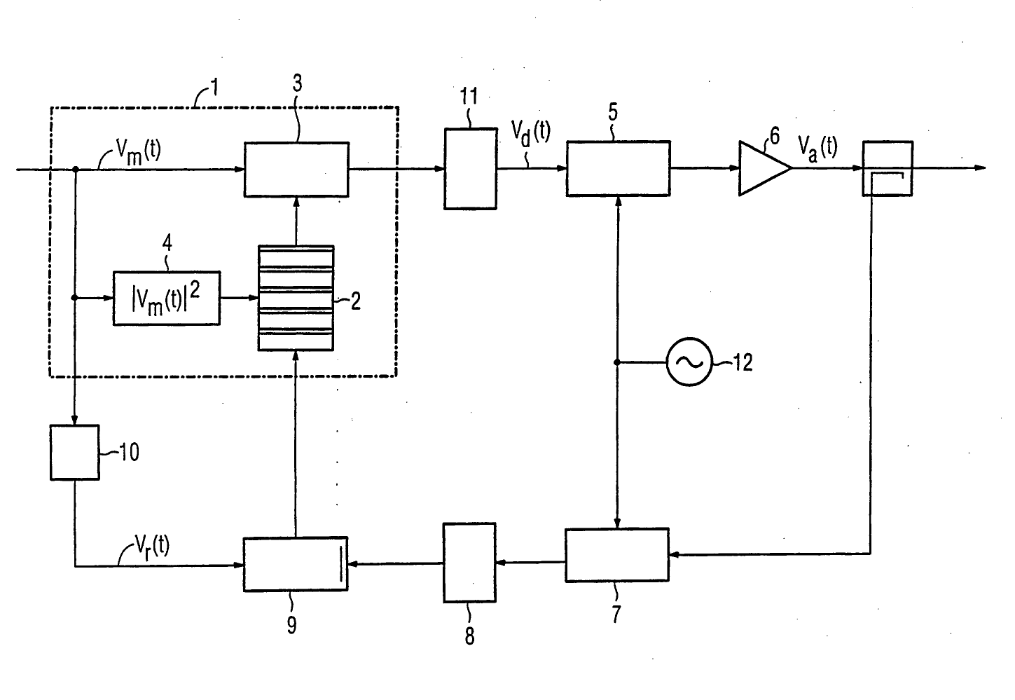

As can be seen from FIG. 1, raw data values Vm which contain information to be transmitted via a transmission output stage in a mobile communication terminal is passed to a predistortion unit 1 which includes a reference table 2 in which a number N of associations are stored between amplitude intervals of the raw data values and associated predistortion values. The respective predistortion values to be selected are thus obtained from the amplitude of the raw data values Vm.

The respective predistortion values to be used from the reference table 2 are multiplied in a complex multiplier 3 by the raw data values which are currently arriving at the complex multiplier 3. The respective suitable predistortion values are selected via an amplitude calculation unit 4, to whose input the raw data values are applied and at whose output the squares of the magnitudes of the raw data values are produced, and are passed to the reference table 2.

An output signal from the complex multiplier 3 in the predistortion unit 1 is passed to a D/A converter 11 in order to produce an analog signal Vd, which is applied to the input of a quadrature modulator 5 which modulates the analog signal Vd onto a suitable carrier. An output signal from the quadrature modulator 5 is passed to a power amplifier 6, which provides the desired gain and produces an output signal Va which is emitted via an antenna (not shown).

For financial reasons, the power amplifier 6 is chosen such that at least some of the amplitudes of the output signal from the quadrature modulator 5 lie in a non-linear operating range of the power amplifier 6, that is to say a characteristic of the power amplifier 6 is non-linear for at least some of the amplitudes which occur in the output signal from the quadrature modulator 5.

Both amplitude and phase errors occur in the output signal from the quadrature modulator 5 owing to the non-linearity of the characteristic of the power amplifier 6. In addition, adjacent channel interference occurs owing to the formation of harmonics and mixed frequencies in the power amplifier 6, when the transmission output stage is being used in accordance with the requirements in the mobile communication terminal or in a base station in a mobile radio network.

The amplitude and phase distortion which results from the non-linearity of the characteristic of the power amplifier 6 can be compensated for via the complex multiplier 3 using the predistortion values in the reference table 2. In this case, a real part of the predistortion values is used to compensate for any amplitude error, and an imaginary part of the predistortion values is used to compensate for any phase error in the power amplifier 6. Irrespective of the extent to which phase distortion is significant in the power amplifier 6 that is used is significant, it is also possible to use real predistortion values and a single multiplier for a simplified embodiment of the present invention, so that only the amplitude error in the power amplifier 6 is compensated for.

The entries in the reference table 2 are updated adaptively. The procedure for this is as follows:

The output signal Va from the power amplifier 6 is tapped off and supplied to a quadrature demodulator 7 in the transmission output stage which, in the same way as the quadrature modulator 5, is connected in the normal manner to a local oscillator 12 that produces carrier frequencies.

In the course of further feedback of the output signal Va in baseband, such signal is passed to an A/D converter at whose output a digital signal Vr is produced which contains output signal values from the power amplifier 6. The signal Vr is passed to a first input of an adaptation unit 9 which has a second input to which the digital raw data signal Vm which contains the raw data values is applied. In the process, the digital raw data signal Vm passes through a delay unit 10 whose object is to delay the raw data signal Vm in such a way that raw data values and output signal values which correspond to one another in time are applied to the two inputs of the adaptation unit 9.

An object of the adaptation unit 9 is to convert any changes in the operating behavior of the power amplifier 6 which influence the amplitude and phase distortion to a change in the predistortion values in the reference table 2. In order to save computation power, the adaptation unit 9 operates with the aid of raw data values and output data values which are collected within a time window. Since, in contrast to the prior art, continuous adaptation is not carried out, the selected time window normally will have gaps with respect to the N amplitude intervals for the raw data values, which gaps can be closed through calculation by a suitable algorithm.

Before adaptation can be carried out by the adaptation unit 9, a suitable value first of all must be calculated for a delay time Vd in the delay unit 10. For this purpose, the delay time τD is estimated using the digital output signal Vr that is fed back within the time window under consideration, through a correlation with the digital raw data value signal Vm, in which case the required accuracy for the delay time τD can be achieved through appropriate interpolation. In principle, this creates the preconditions for adaptation of the predistortion values in the reference table.

Both raw data values and output signal values are then collected in the time window under consideration via the adaptation unit 9, with the value range for the amplitudes of the raw data values being subdivided into the N intervals. The squares of the magnitudes of the raw data values and of the output signal values from the power amplifier 6 are then calculated.

A mean value is formed for each of the amplitudes of the raw data values and of the output signal values which occur in a joint raw data amplitude interval n, thus resulting in N mean value pairs. Coefficients of a polynomial which describes the amplitudes of the output signal values as a function of the amplitudes of the raw data values are then calculated. This leads to smoothing of the curve which describes the relationship between these variables. The polynomial is then used for interpolation/extrapolation of missing amplitude pairs (raw data value/output signal value) in order to fill all of the N amplitude intervals with value pairs.

The output signal amplitudes are then normalized by using the raw data amplitude mean value and the output signal amplitude mean value from the highest amplitude interval N to calculate the overall gain of the power amplifier 6.

The predistortion values in the reference table 2 are then updated using a least mean square error method, in which case the real and imaginary parts of the raw data values and output signal values are compared in an amplitude interval n in order to calculate that predistortion value which provides the best possible compensation for amplitude and phase distortion in the power amplifier 6, as a multiplication factor for the raw data value from the relevant amplitude interval n. In this case, both any amplitude discrepancies with regard to the desired overall gain and any phase discrepancies between the raw data value and output signal value resulting from distortion in the power amplifier 6 are recorded and used to update the predistortion values.

Although the present invention has been described with reference to specific embodiments, those of skill in the art will recognize that changes may be made thereto without departing from the spirit and scope of the present invention as set forth in the hereafter appended claims.

1-8. (canceled)

9. A method for adaptive predistortion of digital raw data values for a transmission output stage of a communication appliance, the transmission output stage having a power amplifier, and the communication appliance being one of a mobile communication terminal and a base station in a mobile radio network, the method comprising:
predistorting the raw data values by multiplying the raw data values by predistortion values from a reference table to compensate for amplitude-dependent and phase-dependent distortion in the power amplifier, wherein the reference table contains an association between amplitudes of the raw data values and predistortion values;
feeding back output signal values from the power amplifier to an adaptation unit;
passing the raw data values to the adaptation unit;
comparing, in the adaptation unit, raw data values and output signal values that correspond to one another in time to assess the distortion in the power amplifier; and
adapting the reference table, based on results from step of comparing, during operation of the power amplifier;
wherein the adaptation unit operates discontinuously and the predistortion values in the reference table are interpolated or extrapolated at least for raw data values which do not occur.

10. A method for adaptive predistortion of digital raw data values as claimed in claim 9, wherein the adaptation is carried out within time windows based on the results from the step of comparing.

11. A method for adaptive predistortion of digital raw data values as claimed in claim 10, the method further comprising defining an interval between successive time windows is defined as a function of external parameters which influence the distortion in the power amplifier and of any desired interference suppression.

12. A method for adaptive predistortion of digital raw data values as claimed in claim 9, the method further comprising:
calculating a polynomial for the amplitudes of the output signal values as a function of the amplitudes of the raw data values for each time window; and
determining the predistortion values in the reference table based on the function values of the polynomial.

13. A method for adaptive predistortion of digital raw data values as claimed in claim 12, wherein the polynomial is calculated based on a predetermined number of mutually adjacent amplitude intervals of the raw data values, and wherein each amplitude interval is associated with a mean value for the raw data values which occur in the respective amplitude interval and with a mean value of the associated output signal values.

14. A method for adaptive predistortion of digital raw data values as claimed in claim 9, wherein real predistortion values are used for processing.

15. A method for adaptive predistortion of digital raw data values as claimed in claim 9, wherein complex predistortion values are used for processing.

16. An apparatus for linearization of a transmission amplifier in a communication appliance, in a communication appliance, the communication appliance being one of a mobile communication terminal and a base station in a mobile radio network, the apparatus comprising:
a multiplier for multiplication of digital raw data values by predistortion values in order to compensate for amplitude-dependent distortion in a power amplifier, of the transmission amplifier, wherein the reference table contains an association between amplitudes of the raw data values and predistortion values; and
an adaptation unit to which output signal values from the power amplifier and the raw data values are passed synchronized in time and which is designed for adaptation of the reference table during operation of the power amplifier, with the adaptation unit has a timer for defining a time window which is used for discontinuous adaptation of the reference table and interpolates/extrapolates the reference table, at least for raw data values which do not occur.
